(19) United States
(12) Patent Application Publication
(10) Pub. No.: US 2005/0279977 A1
(43) Pub. Date: Dec. 22, 2005

(54) Winch line tensioner

(76) Inventor: Charles Robert Kerry, Longville, LA (US)

Correspondence Address: Charles R. Kerry, 846 Memorial Church Rd., Longville, LA, 70652, US

(21) Appl. No.: 10/861,287

(22) Filed: Jun. 2, 2004

(51) Int. Cl. B66D 1/00

(52) U.S. Cl. 254/323

(57) ABSTRACT

A compressible devise for a winch line for minimizing slack accumulation in the raps of line on the winch spool. A compressible device formed of a resilient, durable material with a hole traversing there through is slid able disposed on the winch line between the hook and the fairlead. This device will be compressed between the hook and the fairlead when the winch is not in use. The stored energy in the devise during compression will exert a force against the hook and the fairlead thus holding tension on the winch line. This will not allow slack to accumulate in the raps of line on the winch line spool.

### BACKGROUND OF THE INVENTION

1. Field of the Invention

The present invention relates to a winch line tensioner and method and, more particularly, to a device and a method for minimizing slack in the raps on a winch line spool while the winch is not in use.

2. Discussion of the Background

Off-road four-wheeling is a major part of many people's lives, whether it is recreational or job related. Most off-road vehicles and ATV's are equipped with a recovery winch. The winch is a very powerful tool, but it can be dangerous as well. When the winch is in use the winch line is under severe tension. If the winch line has been abused and/or damaged it can become a safety hazard to the operator and/or vehicle in the event of winch line failure. It is the operators' responsibility to inspect the winch line periodically for damage. One of the most common ways a winch line becomes damaged is slack accumulation in the raps of line on the spool. When the winch is in use the last two raps of line on the spool are pulled very tight, if there is slack in the underlying raps of line on the spool the top two raps will be pulled down between them. This causes pinching and fraying of the winch line, which will eventually cause winch line failure. The most common way slack is accumulated is when the winch is not in use. Most operators will winch the hook up to the fairlead (rollers) but will not winch it up tight because of the potential hazards of equipment damage. Therefore, the hook is left hanging on a short amount of line (one or two inches). When the vehicle is in motion the bouncing and swaying of the vehicle will cause the raps of line on the spool to loosen by absorbing the slack. Over time the raps will gradually loosen all the way down to the spool. During the process of winch operation the winch line is under severe tension. Where the line makes its last two raps on the spool, there is a great force exerted on the underlying raps. If the underlying raps are loose the top two raps will be pulled down between the underlying raps. This will lead to pinching and fraying of the winch line and eventually to winch line failure.

Some operators will hook to a part of the vehicle (brush guard, bumper, skid plate, exc.) And winch out the slack to stow the hook. This can be a hazard if the operator inadvertently over winds the winch once he has winched out all of the slack. This can break the cable or hook, or bend the brush guard, bumper, exc.

A need exists for minimizing the slack accumulation in winch line spool raps, and a safer manner of stowing a winch line hook.

### SUMMARY OF INVENTION

The present invention provides a device that will prevent slack from accumulating in the raps of line on the spool of a winch when not in use. A device made of compressible and resilient material with a hole traversing there through is slid ably disposed on the winch line between the hook and the fairlead, thus allowing the device to be positioned on the winch line out of the way during winch operation. When the hook is winched up to the fairlead (roller) with the winch line tensioner in place; it will be compressed between the two. With this devise compressed, the stored energy will exert force against the hook and the fairlead (rollers) thus holding tension on the winch line. Thus not allowing slack to accumulate in raps of line on the winch line spool.

### BRIEF DESCRIPITION OF DRAWINGS

FIG. 1 is an illustration showing a winch with its line extended out from the winch and the winch line tensioner of the present invention installed on the line.

FIG. 2 is the illustration of FIG. 1 in which the extended line has been retracted with the winch line tensioner of the present invention compressed between the hook and the fairlead providing tension on the cable and holding the hook in a upright position for safe access.

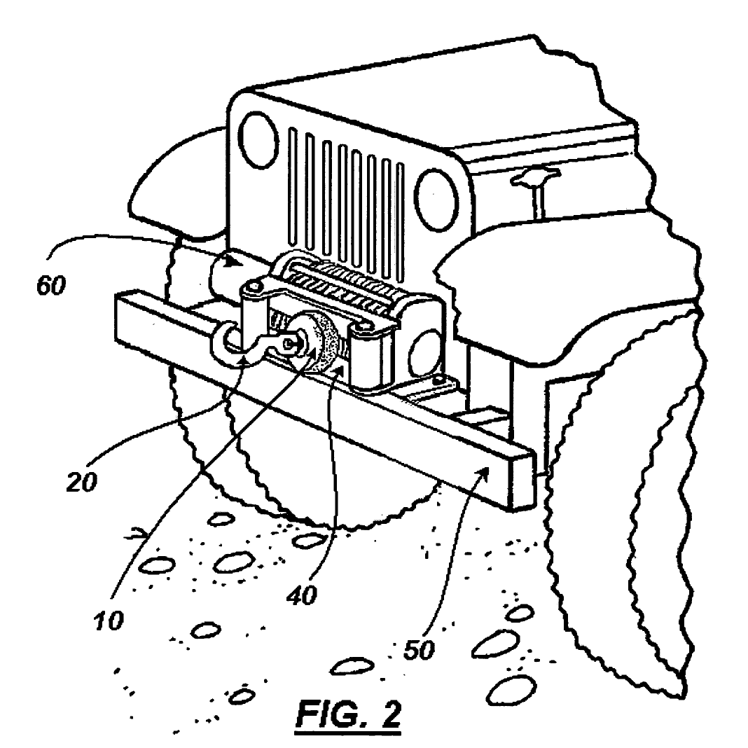

FIG. 3 is a perspective view of the preferred embodiment and the installation of the winch line tensioner of the present invention.

FIG. 4 is a view showing the winch line tensioner of the present invention installed onto a winch line.

FIG. 5 is a perspective view of the winch line tensioner of the present invention in a compressed state, exerting fours against the hook and the fairlead (rollers) thus holding tension on the winch line, and holding the hook in a upright position.

FIG. 6 is a perspective view of a second embodiment of the winch line tensioner of the present invention.

FIG. 7 is a perspective view of a third embodiment of the winch line tensioner of the present invention.

FIG. 8 is a perspective view of a fourth embodiment of the winch line tensioner of the present invention.

### DETAILED DESCRIPTION OF THE INVENTION

1. Overview

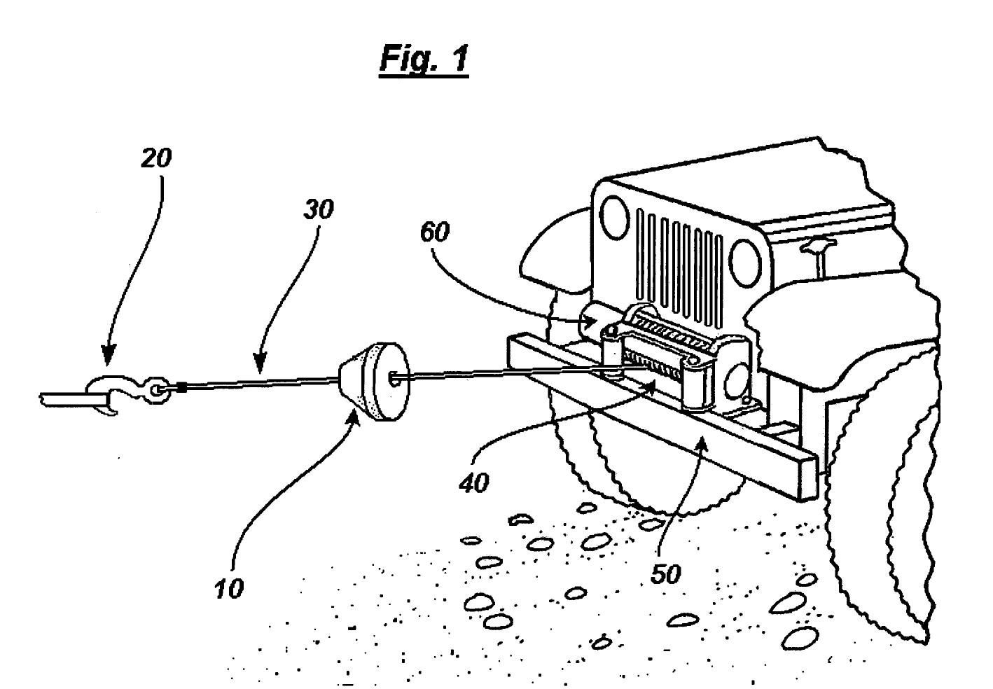

The winch line tensioner 10 of the present invention, as shown in FIG. 1, is installed on a winch line 30 between the hook 20 and the fairlead 40, with the winch line 30 in use. In the following the term “winch line” is used to discuss the invention set forth in the drawings. The term “winch line” shall mean wire rope, metal cable, nylon line, or any other lines manufactured of material to meet winching load requirements. In the following the term “fairlead” shall mean cable guide, roller, or any other means of guiding the cable onto the spool.

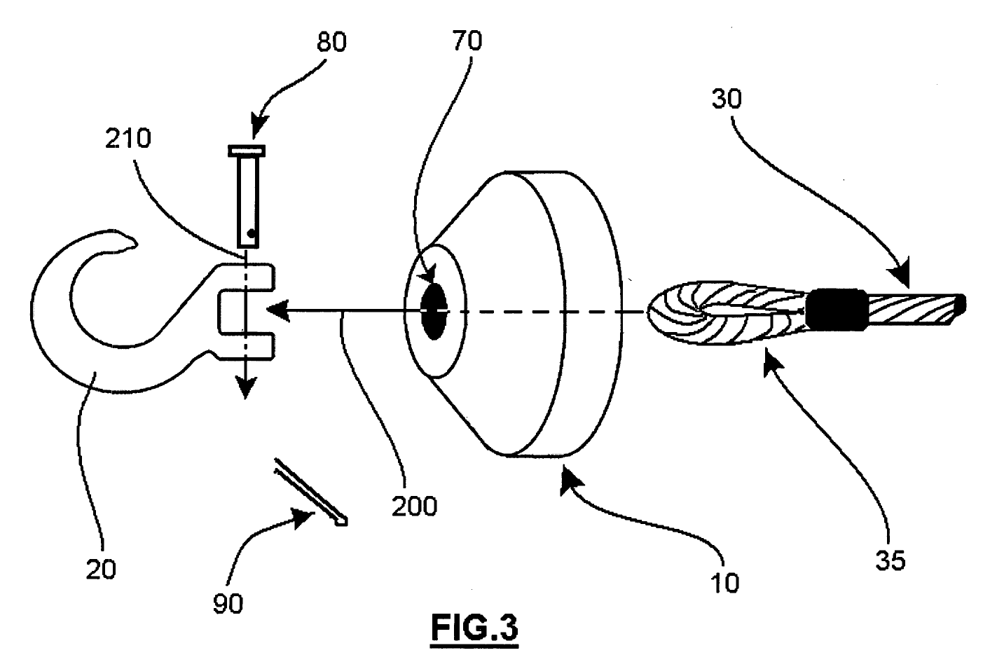

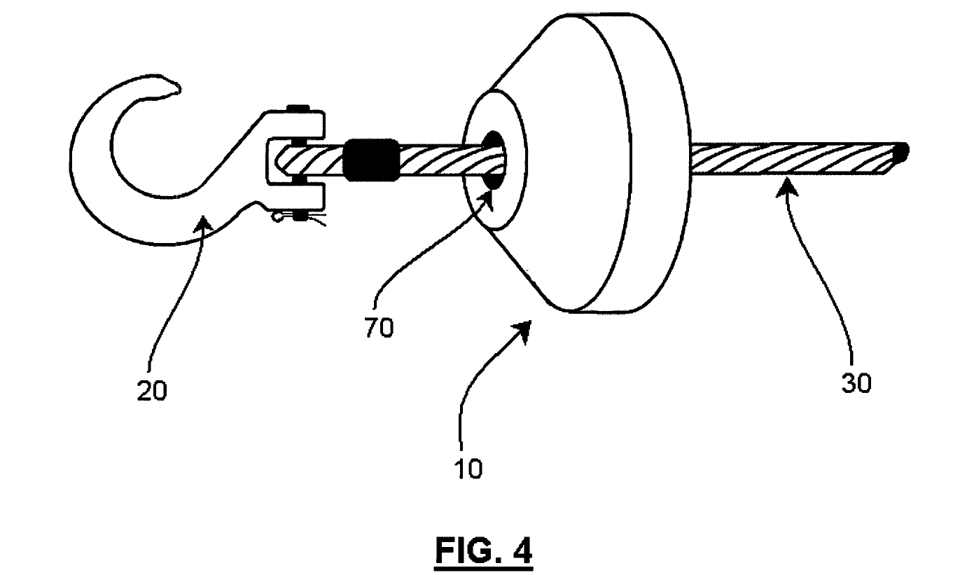

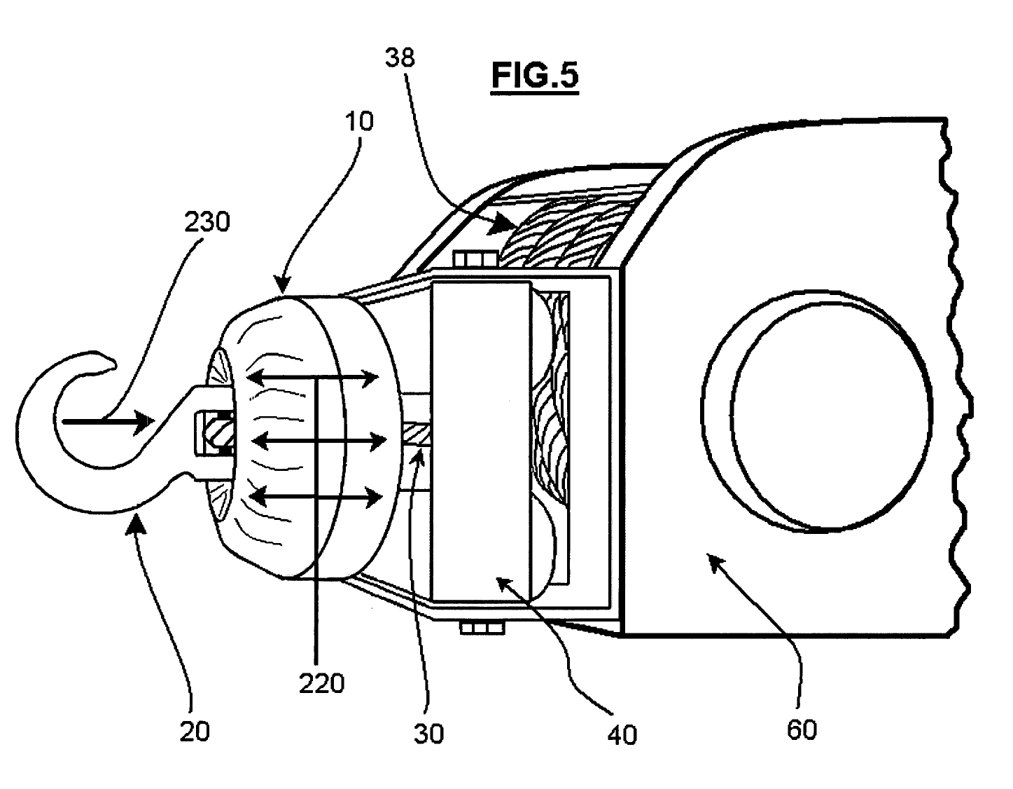

The winch line tensioner 10 of the present invention is installed onto the winch line 30 as shown in FIG. 3. The winch line tensioner 10 has a hole 70 traversing through for the winch line 30 to pass through, thus allowing device 10 to be slid able on the winch line 30. The device 10 can slid along the winch line 30 away from the fairlead 40 and hook 20 during winching operation as shown in FIG. 1. The hole 70 is large enough for winch line eye 35 to be forced through during installation, as shown in FIG. 3. The hole 70 is small enough that the hook 20 cannot enter during compression as shown in FIG. 5. With the hook 20 reinstalled as shown in FIG. 4. the winch line 30 can be completely retracted pulling hook 20 against device 10 as shown in FIG. 5. by arrow 230, compressing winch line tensioner 10 between hook 20 and fairlead 40 as shown in FIG. 5. As the winch line tensioner 10 starts to be compressed between the fairlead 40 and the hook 20 it will cause a noticeable strain on the winch 60, at which time the operator will stop the winching process. This action provides stored energy as shown in FIG. 5 arrow 220 to keep tension on the winch line 30 which will not allow slack to accumulate in raps of line 38 on the spool when the winch 60 is not in use. The present invention 10 will be manufactured in different sizes to accommodate different size winches, and different size winch lines.

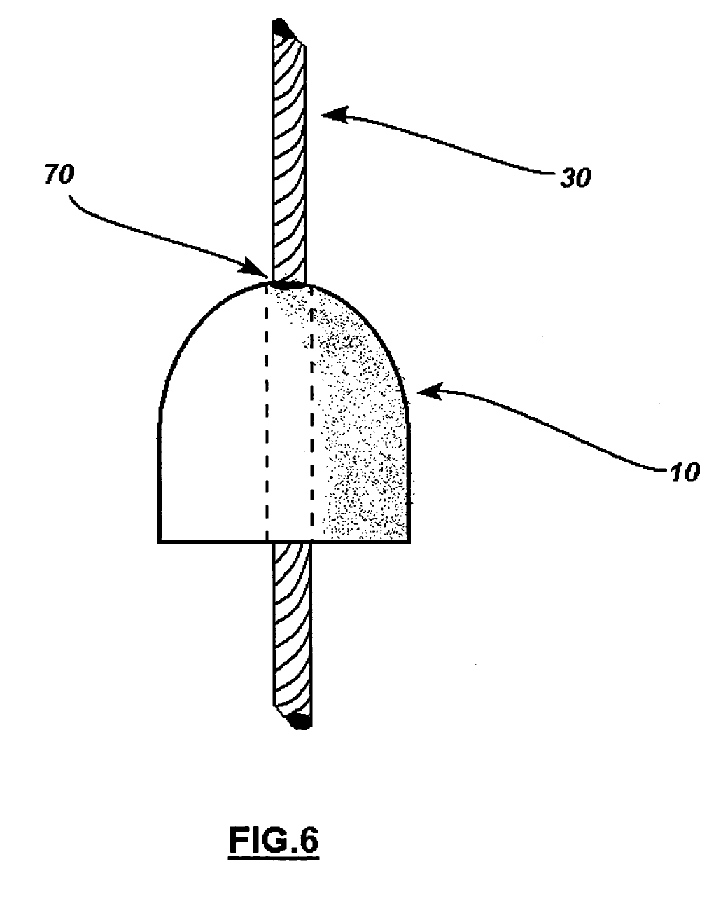

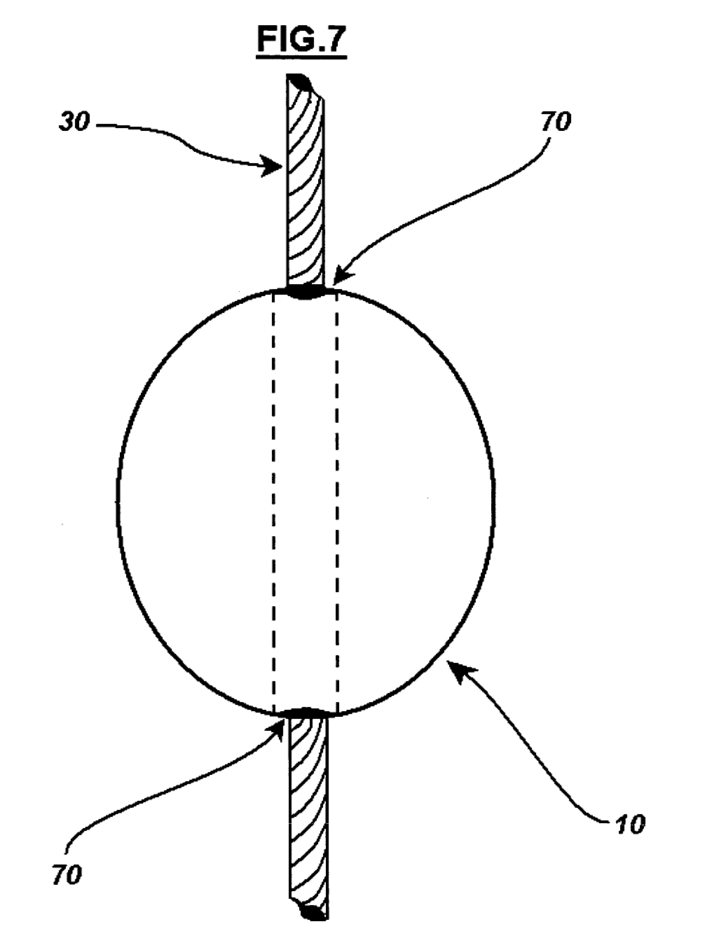

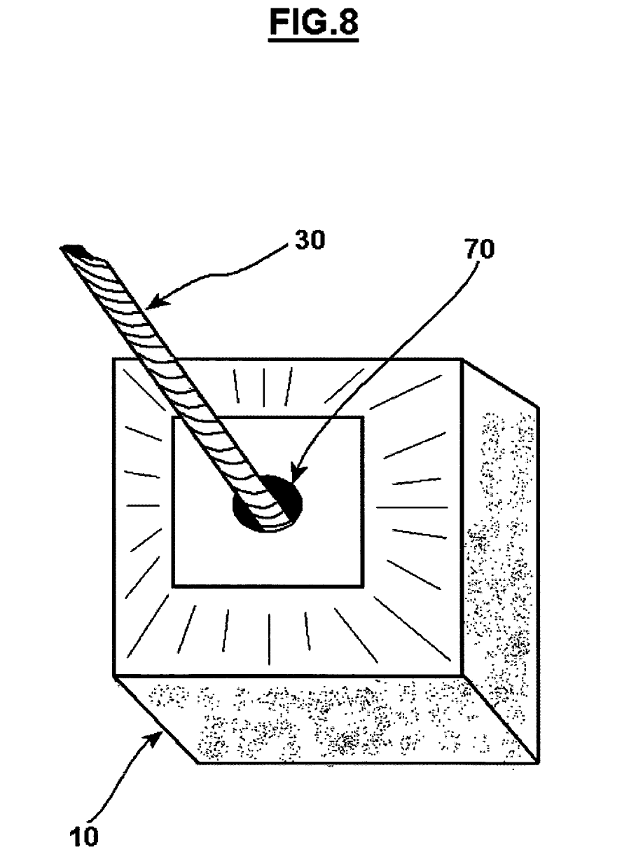

The present invention 10 can be manufactured in different embodiments such as shown in FIG. 6-8. The present invention 10 will be manufactured of a compressible, durable, and resilient material. The present invention 10 can be manufactured in any color, such as bright colors for safety or the color of the operators' vehicle.

The above disclosure sets forth a number of embodiments of the present invention. Those skilled in this art will, however, appreciate that other arrangements or embodiments, not precisely set forth, could be practiced under the teachings of the present invention and that the scope of the following claims.

1. A compressible device for a winch having a winch line, said device comprising: A device of compressible material with a hole traversing there through is slid ably disposed on the winch line between the hook (cable end hardware) and the fair lead. When compressed will exert force against the hook and the fair lead. Thus holding tension on the winch line not allowing slack to accumulate in the raps of winch line on the spool.
II. The compressible device of claim 1 is formed of a resilient and durable material, with a hole traversing through large enough to slide freely along the winch line during winching operation.
III. The compressible device of claim 1 can be of many different shapes, though large enough to provide enough stored energy to hold tension on the cable when compressed.
IV. The compressible device of claim 1 can be made of any color.
